(19) United States
(12) Patent Application Publication
(10) Pub. No.: US 2026/0149487 A1
(43) Pub. Date: May 28, 2026

(54) BACKSCATTER COMMUNICATION METHOD AND APPARATUS BASED ON NON-ORTHOGONAL MULTIPLE ACCESS USING RECONFIGURABLE INTELLIGENT SURFACE

(71) Applicant: Electronics and Telecommunications Research Institute, Daejeon (KR)

(72) Inventors: Hoondong NOH, Daejeon (KR); Hyung Sik JU, Daejeon (KR); Haejoon JUNG, Anyang-si (KR); Byungha YOU, Incheon (KR); Jijun HWANG, Suwon-si (KR)

(21) Appl. No.: 19/395,444

(22) Filed: Nov. 20, 2025

(30) Foreign Application Priority Data
Nov. 25, 2024 (KR) 10-2024-0170137
Aug. 6, 2025 (KR) 10-2025-0108309

(51) Int. Cl. H04B 7/04; H04B 7/06; H04B 17/318

(52) U.S. Cl. CPC H04B 7/04013; H04B 7/0626; H04B 17/328

(57) ABSTRACT

A method of a backscatter receiver may comprise: receiving a combined backscattered signal in which direct backscattered signals transmitted from a first backscatter node (BSN) and a second BSN included in a first cluster through direct paths and reflected backscattered signals reflected by an RIS node are combined; demodulating, among the direct backscattered signals, a backscattered signal having a larger received signal strength based on a comparison between a received signal strength of a first direct backscattered signal from the first BSN and a received signal strength of a second direct backscattered signal from the second BSN; generating a remaining signal by removing, from the combined backscattered signal, the backscattered signal having the larger received signal strength based on the demodulated backscattered signal; and demodulating the remaining signal.

### CROSS-REFERENCE TO RELATED APPLICATIONS

This application claims priority to Korean Patent Applications No. 10-2024-0170137, filed on Nov. 25, 2024, and No. 10-2025-0108309, filed on Aug. 6, 2025, with the Korean Intellectual Property Office (KIPO), the entire contents of which are hereby incorporated by reference.

### BACKGROUND

### 1. Technical Field

The present disclosure relates to an Internet of Things (IoT) network technique, and more particularly, to a backscatter communication technique in an IoT network.

### 2. Related Art

An Internet of Things (IoT) network may be configured to enable various IoT nodes to communicate with each other using wireless communication technologies. The IoT nodes may be low-power devices that include software, sensors, and other functional components. The IoT nodes may communicate with non-IoT devices and/or external systems through the Internet or other communication networks. Such IoT nodes are increasingly being used in a wide range of applications, from household products to sophisticated industrial tools.

Backscatter communication technology is designed to improve energy efficiency in low-power devices such as IoT nodes and is highly useful in environments where battery replacement is difficult. IoT nodes using backscatter communication may employ an orthogonal multiple access (OMA) scheme. However, the OMA scheme provides low spectral and energy efficiency, resulting in limited performance in large-scale IoT networks.

To improve spectral efficiency and energy efficiency of IoT nodes, a non-orthogonal multiple access (NOMA) scheme has been introduced. However, when the NOMA scheme is applied to IoT nodes, communication quality may be degraded due to increased signal interference.

Meanwhile, in mobile communication systems, technologies such as integrated access and backhaul (IAB) and network-controlled repeaters (NCRs), which combine user equipment (UE) wireless access with wireless backhaul for the network infrastructure, have been proposed and utilized. According to such IAB and/or NCR technologies, a relay node may perform relay operations between a UE and another access node. However, these technologies have limitations in large-scale IoT networks due to increased complexity and high cost.

To address the above issues, technologies that combine reconfigurable intelligent surface (RIS) technology with a NOMA scheme have been proposed. However, the combination of RIS technology and a NOMA scheme is still in an early research stage, and methods for improving performance and ensuring reliability have not yet been fully developed.

### SUMMARY

The present disclosure for resolving the above-described problems is directed to providing methods and apparatuses for enhancing performance and securing reliability by combining RIS technology and a NOMA scheme.

A method of a backscatter receiver in a backscatter communication system, according to an exemplary embodiment of the present disclosure, may comprise: receiving a combined backscattered signal in which direct backscattered signals transmitted from a first backscatter node (BSN) and a second BSN included in a first cluster through direct paths and reflected backscattered signals reflected by a reconfigurable intelligent surface (RIS) node are combined; demodulating, among the direct backscattered signals, a backscattered signal having a larger received signal strength based on a comparison between a received signal strength of a first direct backscattered signal from the first BSN and a received signal strength of a second direct backscattered signal from the second BSN; generating a remaining signal by removing, from the combined backscattered signal, the backscattered signal having the larger received signal strength based on the demodulated backscattered signal; and demodulating the remaining signal.

The method may further comprise: generating cluster configuration information including information on BSNs included in each of clusters including the first cluster, transmission duration information on a transmission duration in which data transmission of each of the clusters is permitted, and information on a transmission slot allocated to each cluster in a transmission duration based on the transmission duration information; and transmitting the cluster configuration information to all BSNs included in the backscatter communication system.

The combined backscattered signal may be received in a transmission slot of the first cluster based on the cluster configuration information.

The demodulating of the backscattered signal having the larger received signal strength may comprise: comparing the received signal strength of the first direct backscattered signal with the received signal strength of the second direct backscattered signal; and based on the received signal strength of the first direct backscattered signal being greater than the received signal strength of the second direct backscattered signal, performing demodulation on the first direct backscattered signal and on a first reflected backscattered signal from the first BSN reflected by the RIS node.

The method may further comprise: transmitting training duration configuration information of all BSNs included in the backscatter communication system to all the BSNs;

receiving an individual backscattered signal from one BSN for each training slot based on the training duration configuration information; measuring channel state information (CSI) for each of all the BSNs by using the received individual backscattered signals; sorting the BSNs in an order from a BSN having a highest channel gain to a BSN having a lowest channel gain based on the measured CSI for each of all the BSNs; mapping two different BSNs among the sorted BSNs to one cluster; generating cluster configuration information including information on the cluster to which the two BSNs are mapped and information on a transmission slot for each cluster; and transmitting the cluster configuration information to all the BSNs included in the backscatter communication system.

The method may further comprise: determining a reflection coefficient of the first BSN and a reflection coefficient of the second BSN based on the measured CSI for each of all the BSNs; and transmitting the reflection coefficient of the first BSN and the reflection coefficient of the second BSN to the first BSN and the second BSN.

The reflection coefficient of the first BSN and the reflection coefficient of the second BSN may have different values from each other.

The method may further comprise: determining a division coefficient configured as information on a number of reflection elements for the RIS node to reflect backscattered signals from the first BSN and a number of reflection elements for the RIS node to reflect backscattered signals from the second BSN, based on the measured CSI for each of all the BSNs; and transmitting the division coefficient to the RIS node.

The division coefficient may be determined based on a simultaneous transmission and reflection (STAR)-RIS scheme.

A backscatter receiver according to an exemplary embodiment of the present disclosure may comprise at least one processor, wherein the at least one processor may cause the backscatter receiver to perform: receiving a combined backscattered signal in which direct backscattered signals transmitted from a first backscatter node (BSN) and a second BSN included in a first cluster through direct paths and reflected backscattered signals reflected by a reconfigurable intelligent surface (RIS) node are combined; demodulating, among the direct backscattered signals, a backscattered signal having a larger received signal strength based on a comparison between a received signal strength of a first direct backscattered signal from the first BSN and a received signal strength of a second direct backscattered signal from the second BSN; generating a remaining signal by removing, from the combined backscattered signal, the backscattered signal having the larger received signal strength based on the demodulated backscattered signal; and demodulating the remaining signal.

The at least one processor may further cause the backscatter receiver to perform: generating cluster configuration information including information on BSNs included in each of clusters including the first cluster, transmission duration information on a transmission duration in which data transmission of each of the clusters is permitted, and information on a transmission slot allocated to each cluster in a transmission duration based on the transmission duration information; and transmitting the cluster configuration information to all BSNs included in the backscatter communication system.

The combined backscattered signal may be received in a transmission slot of the first cluster based on the cluster configuration information.

In the demodulating of the backscattered signal having the larger received signal strength, the at least one processor may cause the backscatter receiver to perform: comparing the received signal strength of the first direct backscattered signal with the received signal strength of the second direct backscattered signal; and based on the received signal strength of the first direct backscattered signal being greater than the received signal strength of the second direct backscattered signal, performing demodulation on the first direct backscattered signal and on a first reflected backscattered signal from the first BSN reflected by the RIS node.

The at least one processor may cause the backscatter receiver to perform: transmitting training duration configuration information of all BSNs included in the backscatter communication system to all the BSNs; receiving an individual backscattered signal from one BSN for each training slot based on the training duration configuration information; measuring channel state information (CSI) for each of all the BSNs by using the received individual backscattered signals; sorting the BSNs in an order from a BSN having a highest channel gain to a BSN having a lowest channel gain based on the measured CSI for each of all the BSNs; mapping two different BSNs among the sorted BSNs to one cluster; generating cluster configuration information including information on the cluster to which the two BSNs are mapped and information on a transmission slot for each cluster; and transmitting the cluster configuration information to all the BSNs included in the backscatter communication system.

The at least one processor may cause the backscatter receiver to perform: determining a reflection coefficient of the first BSN and a reflection coefficient of the second BSN based on the measured CSI for each of all the BSNs; and transmitting the reflection coefficient of the first BSN and the reflection coefficient of the second BSN to the first BSN and the second BSN.

The reflection coefficient of the first BSN and the reflection coefficient of the second BSN may have different values from each other.

The at least one processor may further cause the backscatter receiver to perform: determining a division coefficient configured as information on a number of reflection elements for the RIS node to reflect backscattered signals from the first BSN and a number of reflection elements for the RIS node to reflect backscattered signals from the second BSN, based on the measured CSI for each of all the BSNs; and transmitting the division coefficient to the RIS node.

The division coefficient may be determined based on a simultaneous transmission and reflection (STAR)-RIS scheme.

A method of a backscatter node in a backscatter communication system, according to an exemplary embodiment of the present disclosure, may comprise: receiving transmission duration configuration information from a backscatter receiver; receiving reflection coefficient information from the backscatter receiver; receiving a continuous wave (CW) signal transmitted from a carrier emitter in a cluster transmission slot allocated to a cluster including the backscatter node based on the transmission duration configuration information; controlling a phase of the received CW signal based on the reflection coefficient information; generating encoded data by performing channel coding on the phase-controlled CW signal; and transmitting a first backscattered signal to the backscatter receiver by backscattering the encoded data, wherein the transmission duration configuration information further includes one or more of a start time of a transmission duration, an end time of the transmission duration, a number of total transmission slots in the transmission duration, a repetition pattern of the transmission duration, and periodicity information of the transmission duration.

The method may further comprise: receiving training duration configuration information from the backscatter receiver; and transmitting a second backscattered signal to the backscatter receiver by backscattering the CW signal received from the carrier emitter in a training slot allocated to the backscatter node based on the training duration configuration information, wherein the training duration configuration information further includes one or more of a start time of a training duration, an end time of the training duration, and a number of slots of the training duration.

According to exemplary embodiments of the present disclosure, methods and apparatuses for combining RIS technology and a NOMA scheme can be provided. The proposed methods that combine RIS technology and a NOMA scheme can secure the reliability of data transmission. In addition, in a large-scale IoT network, the proposed methods can not only improve spectral efficiency but also reduce power consumption of IoT nodes. Furthermore, the proposed methods can have an advantage of predicting system performance based on analytical equations and determining an optimal system operation method. Thus, by combining RIS technology and a NOMA scheme, a backscatter communication system can maximize low-power communication and spectral resource efficiency according to changes in parameters, and can also improve system coverage.

In addition, by constructing a backscatter communication system using RIS technology and a NOMA scheme, issues related to low power, spectral efficiency, and interference control in a large-scale IoT network can be addressed. By controlling a phase and an amplitude of a reflected signal by an RIS node, a reception node can increase received signal strength and improve bit error rate (BER) performance. Moreover, stable and reliable data transmission can be ensured even under varying communication environments. By utilizing a NOMA scheme so that multiple IoT nodes communicate simultaneously, energy utilization of low-power backscatter communication can be further enhanced. Furthermore, an optimization algorithm for an element division coefficient of an RIS node supporting BSNs or a simultaneous transmitting and reflecting RIS (STAR-RIS) can be additionally provided, which can contribute to improvement of BER performance and adaptive configuration for radio environments.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating a NOMA-based RIS-supported backscatter system.

FIG. 4 is a timing diagram illustrating a training duration and a transmission duration in the NOMA scheme system supporting a frame-based transmission protocol.

FIG. 5 is a sequence chart illustrating a demodulation procedure of signals transmitted by BSNs included in one cluster in the NOMA-based RIS-supported backscatter system.

FIG. 6 is a conceptual diagram illustrating signal constellations for symbols received at the BR from the first BSN.

FIG. 7 is a conceptual diagram illustrating signal constellations for symbols received at the BR from the second BSN.

FIG. 8 is a simulation graph illustrating a symbol error rate when the first BSN and the second BSN use a BPSK modulation scheme and a QPSK modulation scheme.

FIG. 9 is a simulation graph illustrating performance according to reflection coefficients of the first BSN and the second BSN.

FIG. 10 is a simulation graph comparing BER performances for the first BSN and the second BSN according to a number of reflection elements of the RIS node.

FIG. 11 is a simulation graph evaluating average BER performance according to a transmission SNR and whether an RIS node is included.

FIG. 12 is a graph evaluating performance according to a transmission SNR and a number of transmitted bits according to a change in a multiple access scheme.

FIG. 13 is a simulation graph comparing BER performances for the first BSN and the second BSN according to a change in a number of reflection elements of the RIS node and a change in a division coefficient value.

FIG. 14 is a flowchart describing a training and backscatter signal reception procedure at the BR of the NOMA-based RIS-supported backscatter system.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, 6G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

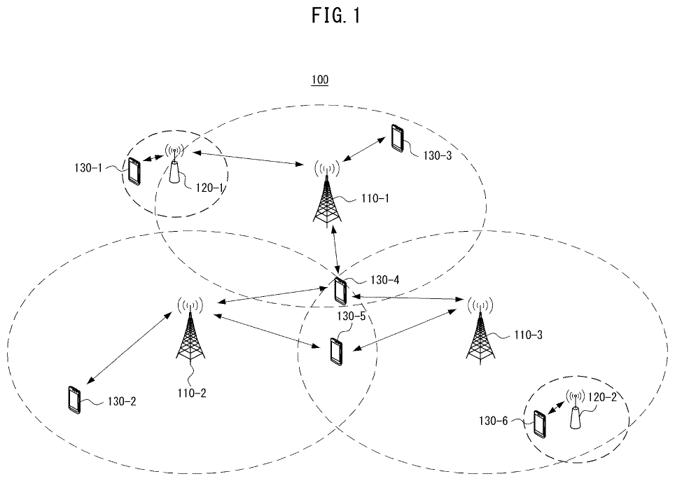

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), etc. specified in the 3rd generation partnership project (3GPP) standards. The 4G communication may be performed in frequency bands below 6 GHz, and the 5G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

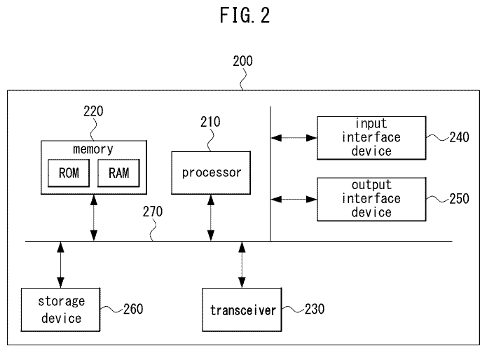

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

In the present disclosure described below, operation methods of a NOMA-based RIS-supported backscatter communication system for a large-scale network are described. The operation methods of the NOMA-based RIS-supported backscatter communication system for a large-scale network according to the present disclosure may include a NOMA-based RIS-supported backscatter transmission method and a successive interference cancellation (SIC)-based decoding method.

### [1] NOMA-Based RIS-Supported Backscatter Transmission Method

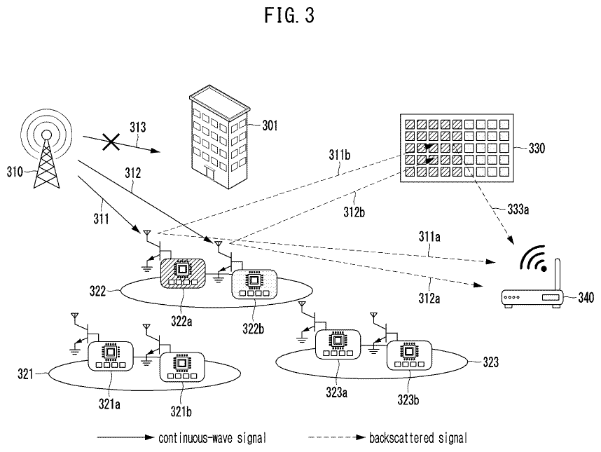

FIG. 3 is a conceptual diagram illustrating a NOMA-based RIS-supported backscatter system.

Referring to FIG. 3, a NOMA-based RIS-supported backscatter system (or network) may include a carrier emitter (CE) 310, a plurality of backscatter clusters 321, 322, and 323 each including one or more backscatter nodes (BSNs), a reconfigurable intelligent surface (RIS) node 330 that reflects signals received from BSNs included in each of the backscatter clusters 321, 322, and 323, and a backscatter receiver (BR) 340 that receives backscatter signals.

The CE 310 may include all or part of the components of the communication node described in FIG. 2, and may transmit continuous-wave signals 311, 312, and 313. Each of the continuous-wave signals 311, 312, and 313 transmitted by the CE 310 may be a signal that is continuously transmitted for a preconfigured time. Each of the continuous-wave signals 311, 312, and 313 may be, for example, a sinusoidal wave suitable for modulation. The continuous-wave signals 311, 312, and 313 may be signals for providing energy to each of BSNs.

In addition, each of the continuous-wave signals 311, 312, and 313 transmitted by the CE 310 may be a beamformed signal in a direction illustrated in FIG. 3 using multiple-input multiple-output (MIMO) antenna technology. As another example, each of the continuous-wave signals 311, 312, and 313 may be a signal transmitted omni-directionally using an omni-antenna.

Each of the clusters 321, 322, and 323 may include one or more BSNs. In the example of FIG. 3, two BSNs are included in each of the clusters 321, 322, and 323. In other words, the first cluster 321 may include two BSNs 321a and 321b, the second cluster 322 may include two BSNs 322a and 322b, and the third cluster 323 may include two BSNs 323a and 323b. However, it should not be understood that each cluster is limited to be composed of two BSNs. In other words, the number of BSNs included in a cluster may be three or more. In certain cases, one cluster may include a different number of BSNs from that of another cluster.

Each of the BSNs illustrated in FIG. 3 may be a low-power IoT node. In the present disclosure, the BSNs may be IoT devices and may be located near the CE 310 to facilitate energy harvesting. A method of configuring the clusters each composed of two or more BSNs is described in more detail below.

Each of the BSNs may have a configuration for harvesting (or storing) energy and configurations for performing backscattering. The BSNs may include antennas for transmission and reception. The BSNs may also have a configuration for adjusting antenna impedance for backscattering. The configuration for adjusting antenna impedance may be one of the configurations for performing backscattering. The configuration for adjusting the antenna impedance of each of the BSNs may include, for example, a radio frequency (RF) transistor. Since the BSNs operate with low power, energy consumption can be reduced, and in order to lower complexity, signals received by the BSNs may be backscattered and transmitted through a binary modulation scheme. The binary modulation scheme by the BSNs may be, for example, a phase shift keying (PSK) modulation scheme or an amplitude shift keying (ASK) modulation scheme. In other words, the BSN may further include a modulator for performing modulation.

Each of the BSN may further include a device (e.g. microprocessor) for controlling the impedance adjustment and/or modulation device described above. In the following description, the device for controlling the BSN is referred to as a controller. The controller of the BSN may adjust a reflection coefficient for a received signal. In the present disclosure, it is assumed that the reflection coefficient controlled by the BSN has two possible adjustable states. For example, the reflection coefficient adjustable by the controller of the BSN in the present disclosure may be controlled such that a received continuous-wave signal and a reflected signal are in the same phase (phase difference of) 0° or in opposite phases (phase difference of) 180°. Although the present disclosure assumes a case where the reflection coefficient adjustable by the controller of the BSN has two possible adjustable states, the present disclosure should not be understood as being limited thereto. For example, when the performance (e.g. low-power performance) of the controller and/or the modulator of the BSN may be further improved and when the method according to the present disclosure described below is extended, the controller of the BSN may perform control over more than two adjustable states for the reflection coefficient.

The RIS node 330 may reflect a signal backscattered by at least one BSN and transmit the signal to the BR 340. The RIS node 330 may have a panel structure in which passive elements, such as metamaterials, are arranged on a plane. The passive elements of the RIS node 330 may reflect a received signal in a desired direction. The signal reflected by the passive elements of the RIS node 330 may be a phase-shifted signal with respect to an input signal input to the passive elements. The RIS node 330 may minimize interference by adjusting a phase shift of the received signal according to a reflection path. The RIS node 330 may also amplify and reflect the received signal. The RIS node 330 may include a controller for controlling reflection, phase shift, and/or amplification of a signal. The controller of the RIS node 330 may be implemented as a microprocessor. The RIS node 330 may be disposed at a distance adjacent to the BR 340. This may be to facilitate collection of backscatter signals transmitted to the BR 340.

The BR 340 may receive a backscattered signal from at least one BSN and may receive a backscattered signal reflected by the RIS node 330. In a time duration of a specific slot, a backscattered signal directly received by the BR 340 from at least one BSN and a backscattered signal reflected by the RIS node 330 may be the same signal. This may be more clearly understood from the following description.

Meanwhile, each of the BSNs described above may operate in an operating mode and a standby mode. When a BSN is in the standby mode, the BSN may not perform a backscattering operation and may harvest (or store) energy from an RF continuous-wave signal emitted from the CE 310. Each of the BSNs may perform computation and/or sensing operations required according to the present disclosure by using stored energy. When the BSN is in the operation mode, the BSNs may control configurations for performing backscattering and may transmit backscattered signals. In other words, the BSNs may transmit backscattered signals by adjusting (or controlling) antenna impedance in the operating mode. The energy harvesting, computation, sensing, and backscatter signal transmission operations performed in each of the BSNs may be controlled by the controller included in each of the BSNs.

In FIG. 3, among the continuous signals 311, 312, and 313 emitted from the CE 310, the first continuous-wave signal 311 is transmitted to the first BSN 322a in the second cluster 322, the second continuous-wave signal 312 is transmitted to the second BSN 322b in the second cluster 322, and the third continuous-wave signal 313 is illustrated as being blocked by a building 301.

The first BSN 322a in the second cluster 322 may receive the first continuous-wave signal 311 in the standby mode and harvest (or store) energy, and the second BSN 322b in the second cluster 322 may also receive the second continuous-wave signal 312 in the standby mode and harvest (or store) energy. The first BSN 322a in the second cluster 322 may transmit backscattered signals 311a and 311b in the operation mode.

According to the example of FIG. 3, the first backscattered signal 311a transmitted by the first BSN 322a may be directly transmitted to the BR 340, and the second backscattered signal 311b transmitted by the first BSN 322a may be transmitted to the RIS node 330. When the second backscattered signal 311b is received, the RIS node 330 may amplify the received signal and reflect a signal 333a toward the direction of the BR 340.

According to the example of FIG. 3, the BR 340 may receive a first backscattered signal 312a that is backscattered by the second BSN 322b and directly transmitted to the BR 340, and may receive a reflected signal 330a that is a reflected version of a second backscattered signal 312b, which is backscattered by the second BSN 322b and transmitted to the RIS node 330. When the second backscattered signal 312b is received, the RIS node 330 may amplify the received signal and reflect the signal 333a toward the direction of the BR 340.

As described above, the backscattered signal received at the BR 340 (direct link) may be classified into a backscattered signal directly received from the BSN and a backscattered signal reflected by the RIS node 330 (reflection link). The backscattered signal received by the BR 340 through the direct link from the BSN may be a signal that has undergone typical wireless channel characteristics. In other words, the backscattered signal received by the BR 340 through the direct link may experience attenuation effects based on distance.

Since the RIS node 330 minimizes interference and reflects (or amplifies and reflects) the backscattered signal, the backscattered signal received by the BR 340 through the RIS node 330 (signal received through a reflection link) may be a backscattered signal having the maximum sensitivity.

In order for the RIS node 330 to reflect an optimal backscattered signal to the BR 340, channel information for two links may be required. For example, channel information (hereinafter referred to as “first channel information”) for a link (hereinafter referred to as “first link”) between the RIS node 330 and the BSN and channel information (hereinafter referred to as “second channel information”) on a link (hereinafter referred to as “second link”) between the RIS node 330 and the BR 340 may be required.

Since the RIS node 330 generally does not use an RF chain, each of the first channel information on the first link and the second channel information on the second link may be estimated as cascaded channels due to coupling between a reflection coefficient matrix of the RIS and the links (first link and second link). Information on the cascaded channels of the first link and the second link may be obtained by using one of a binary and full reflection-based direct cascaded channel estimation (DCCE) scheme, a subspace-based estimation scheme, or a compressed sensing-based channel estimation scheme.

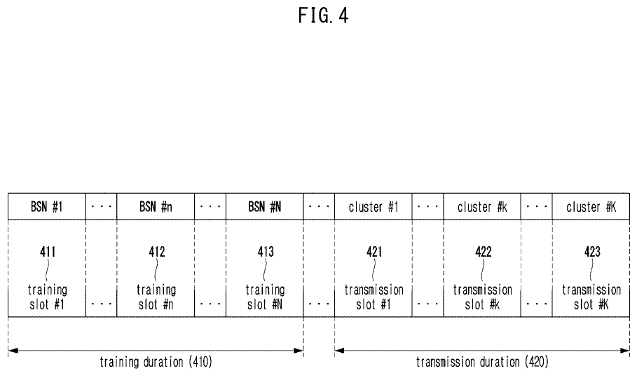

FIG. 4 is a timing diagram illustrating a training duration and a transmission duration in the NOMA scheme system supporting a frame-based transmission protocol.

Before referring to FIG. 4, it should be noted that the BSNs illustrated in FIG. 3 may be N in number (N is a natural number equal to or greater than 2), and clusters including two or more BSNs may be K in number (K is a natural number equal to or greater than 2). In the present disclosure, for convenience of description, a case is assumed in which J (J is a natural number equal to or greater than 1) BSNs for each cluster are deployed in the NOMA scheme system.

According to the example of FIG. 4, a transmission protocol may be a frame-based transmission protocol, and a time division multiple access (TDMA) scheme may be used. The frame-based transmission protocol may include a training duration 410 and a transmission duration 420. The training duration 410 may include N slots 411, . . . , 412, . . . , and 413 for training of the respective N BSNs. In other words, the training duration 410 may include a training slot #1 411 of BSN #1, . . . , a training slot #n 412 of BSN #n, . . . , and a training slot #N 413 of BSN #N. Accordingly, n may have a value equal to or greater than 1 and equal to or less than N.

The transmission duration 420 may include K slots 421, . . . , 422, . . . , and 423 in which each of the K clusters each composed of J BSNs may transmit data based on the NOMA scheme through backscattered signals. In other words, the transmission duration 420 may include a transmission slot #1 421 of cluster #1, . . . , a transmission slot #k 422 of cluster #k, . . . , and a transmission slot #K 423 of cluster #K. Accordingly, k may have a value equal to or greater than 1 and equal to or less than K.

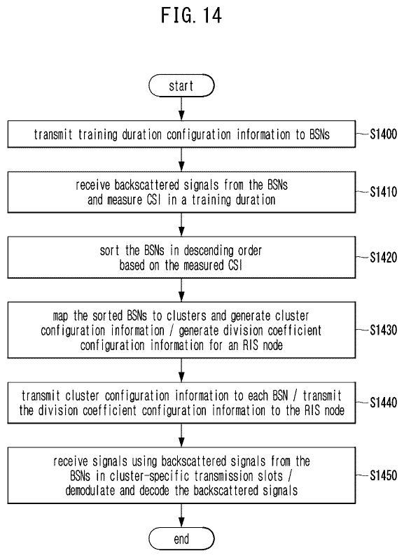

In the training duration 410 of the frame-based transmission protocol, time slots may be preconfigured (or allocated) to the respective BSNs. For example, in the training duration 410, the CE 310 or the BR 340 in the NOMA-based RIS-supported backscatter system may preconfigure (or allocate) time slots to the respective BSNs. The training duration 410 and an operation in which time slots are allocated to the respective BSNs in the training duration 410 are described in more detail in FIG. 14 to be described later.

The training slot #1 411 of the training duration 410 may be configured (or allocated) to BSN #1, the training slot #n 412 of the training duration 410 may be configured (or allocated) to BSN #n, and the training slot #N 413 of the training duration 410 may be configured (or allocated) to BSN #N. In the training duration 410, the RIS node 330 may be in an inactive state.

Each of the BSNs may be in a state in which energy has been harvested so as to be operable before a time point of a training slot allocated thereto. For example, BSN #1 may be in a state in which energy has been harvested so as to be operable before a time point of the training slot #1 411 of the training duration 410. BSN #1 may receive a continuous-wave signal transmitted by the CE 310 during a time duration of the training slot #1 411 and may perform backscattering. In the time duration of the training slot #1 411, BSNs other than BSN #1 may maintain the standby mode. In other words, each of the BSNs may perform backscattering during a time duration of a training slot allocated thereto and may maintain the standby mode during a time not allocated thereto.

The BR 340 may receive a backscattered signal that is backscattered and transmitted by each of the BSNs. A backscattered signal received in one time slot duration may be a signal backscattered by one BSN. The BR 340 may measure (or estimate) channel state information (CSI) for channels from the BSNs to the BR 340 by using backscattered signals received in the respective training slots in the training duration 410. The BR 340 may calculate (or identify) a degree of channel gain between a specific BSN and the BR 340 from the CSI measured (or estimated) from the respective BSNs.

The BR 340 may sort the BSNs in order from a BSN having the highest CSI value to a BSN having the lowest CSI value by using the measured CSI values. In other words, the BR 340 may sort the BSNs in a descending order based on the measured CSI values. The BR 340 may configure a first group composed of BSNs having high channel gains and a second group composed of BSNs having low channel gains. Thereafter, the BR 340 may form a cluster by selecting one BSN from each of the first and second groups. As illustrated in FIG. 3, one cluster may be composed of two BSNs. As described in FIG. 3, the case where one cluster is composed of two BSNs is merely for facilitating understanding of the present disclosure and should not be understood as being limited thereto.

The BR 340 may preconfigure (or allocate) transmission slots to the respective clusters in the transmission duration 420 of the frame-based transmission protocol. Accordingly, the BSNs included in each cluster may know in advance a transmission slot of the cluster to which the BSNs belong.

The transmission slot #1 421 of the transmission duration 420 may be configured (or allocated) to cluster #1, the transmission slot #k 422 of the transmission duration 420 may be configured (or allocated) to cluster #k, and the transmission slot #K 423 of the transmission duration 420 may be configured (or allocated) to cluster #K. In the transmission duration 420, each of the clusters may perform transmission based on the NOMA scheme only in a slot allocated thereto and may maintain a standby state in slots not allocated thereto.

For example, the BSNs included in cluster #1 may be in a state in which energy has been harvested so as to be operable before a time point of the transmission slot #1 421 of the transmission duration 420. The BSNs included in cluster #1 may transmit backscattered signals to the BR 340 by receiving a continuous-wave signal transmitted by the CE 310 during a time duration of the transmission slot #1 421 and performing backscattering. In the time duration of the transmission slot #1 421, BSNs other than the BSNs included in cluster #1 may maintain the standby mode. In other words, each of the BSNs may perform backscattering only during a time duration of the transmission slot allocated to the cluster to which the BSN belongs and may maintain the standby mode during a time not allocated thereto.

A backscattered signal may be received by the BR 340 through a path (e.g. 311a) directly transmitted to the BR 340. In addition, the backscattered signal may be transmitted to the RIS node 330 (e.g. 311b) and may be received by the BR 340 through a path (e.g. 333a) reflected by the RIS node 330. In other words, the BR 340 may receive the signal of the direct link and the signal of the reflection link together.

A signal transmitted to the BR 340 through backscattering by an i-th BSN may be expressed as Equation 1 below.

$${r}_{i} = \sqrt{{P}_{T} {Γ}_{i}} {h}_{f , i} {x}_{i} \qquad [ Equation l ]$$

In Equation 1, P_{T} may denote a transmission power of the CE 310, Γᵢ may denote a power reflection coefficient of the i-th BSN, h_{f,i} may denote a forward channel coefficient of a channel in which only path loss exists without fading, and x; may indicate an information symbol having a unit power and modulated by binary phase shift keying (BPSK).

A signal received by the BR 340 from the i-th BSN may include a signal received through a direct link and a signal received through a reflection link. When the signal received from the i-th BSN through the direct link is defined as Equation 2 below and the signal received from the i-th BSN through the reflection link is defined as Equation 3 below, a signal y received by the BR 340 from the BSNs included in a specific cluster may be rearranged as Equation 4 below.

$$\frac{{h}_{d , i}}{\sqrt{L ( {d}_{d , i} )}} \qquad [ Equation 2 ]$$

$$\frac{{g}_{r}^{H} Θ {f}_{i}}{\sqrt{L ( {d}_{b , i} ) L ( ( {d}_{I} )}} \qquad [ Equation 3 ]$$

$$y = {\sum }_{i = 1}^{J} \sqrt{{P}_{T} {Γ}_{i}} {h}_{f , i} ( \frac{{h}_{d , i}}{\sqrt{L ( {d}_{d , i} )}} + \frac{{g}_{r}^{H} Θ {f}_{i}}{\sqrt{L ( {d}_{b , i} ) L ( ( {d}_{I} )}} ) {x}_{i} + w \qquad [ Equation 4 ]$$

In Equation 2, h_{d,i} may denote a channel function between the i-th BSN and the BR 340, d_{b,i} may denote a distance between the BR 340 and the i-th BSN, and L(d_{I}) may denote path attenuation based on the distance between the BR 340 and the i-th BSN.

In Equation 3,

$${g}_{r}^{H} Θ {f}_{i}$$

may represent a second IK among RIS reflection links. Here, it is assumed that reflection elements of the RIS node 330 independently reflect an incident signal, and thus no coupling occurs between adjacent elements. In addition, in Equation 3, d_{I} may denote a distance between the RIS node 330 and the CE 310, L(d_{I}) may denote attenuation based on the distance between the RIS node 330 and the CE 310, d_{b,i} may denote a distance between the RIS node 330 and the i-th BSN, and L (d_{b,i}) may denote attenuation based on the distance between the RIS node 330 and the i-th BSN.

In Equation 4, the received signal y may be expressed as a sum of signals received from the J BSNs included in one cluster. In Equation 4, w may denote noise and may denote additive white Gaussian noise (AWGN), for example.

### [2] Successive Interference Cancellation (SIC)-Based Decoding Method

In the NOMA-based RIS-supported backscatter system according to the present disclosure, all J BSNs included in one cluster may transmit signals to the BR 340 through backscattering in a time duration allocated as a transmission slot. The BR 340 may receive a combined signal from the J BSNs included in a specific cluster. Here, the combined backscattered signal may denote a backscattered signal in a form in which backscattered signals transmitted by the respective BSNs and backscattered signals reflected by the RIS node 330 are combined, as in Equation 4 above.

The BR 340 may acquire CSI for the respective BSNs by using a channel estimation scheme. The CSI for the respective BSNs may be acquired in advance through the training duration 410 as described with reference to FIG. 4. The BR 340 may separate respective BSN signals from the combined backscattered signal received from multiple BSNs as in Equation 4 based on the acquired CSI. A procedure for separating the combined backscattered signal received from multiple BSNs may be performed as follows.

Step 1: The BR 340 may first detect a signal having the largest channel gain from the combined backscattered signal received from the J BSNs. In this case, when the operation is the first operation, J may be the number of all BSNs included in the specific cluster. Here, the signal having the largest channel gain may be selected based on channel gains acquired in the training duration 410 described with reference to FIG. 4. The BR 340 may decode the signal having the largest channel gain based on a maximum-likelihood detection (MLD) scheme.

Step 2: The BR 340 may remove the signal having the largest channel gain from the combined backscatter signal received from the J BSNs based on the above demodulation result. Step 3: It may be determined whether a value of J-1 is zero.

Step 4: When the value of J-1 is zero, the signal separation procedure may be terminated. Step 5: When the value of J-1 is not zero, J-1 may be set as a new value of J, and Step 1 may be returned to.

By performing iterated operations as described above, signals received from all BSNs may be separated. Thereafter, interference between BSN signals may be removed.

[3] Exemplary Embodiment in a Case where Two BSNs are Included in One Cluster

In the following description, for convenience of description, a procedure in which the BR 340 receives and restores a signal in a case where two BSNs are included in one cluster is described. However, this is merely one exemplary embodiment, and a case where three or four or more BSNs are included in one cluster may be performed through an extension of the method according to the following description.

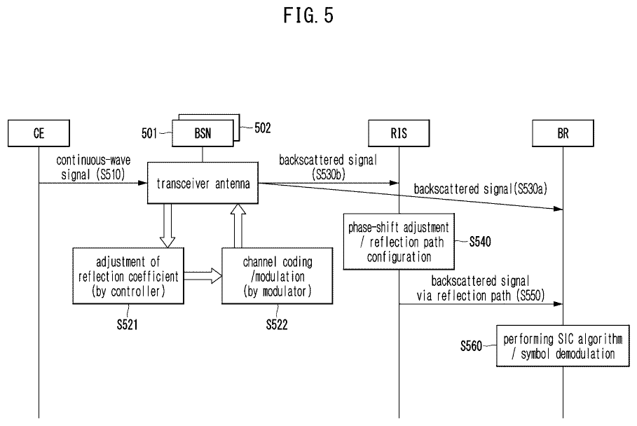

FIG. 5 is a sequence chart illustrating a demodulation procedure of signals transmitted by BSNs included in one cluster in the NOMA-based RIS-supported backscatter system.

Before referring to FIG. 5, each of components illustrated in FIG. 5 may be the components described in FIG. 3. However, in the exemplary embodiment of the present disclosure, a case is assumed in which two BSNs 501 and 502 are included in one cluster, and it should be noted that reference numerals different from those of FIG. 3 are used for convenience of description. The two BSNs 501 and 502 may generally perform the same operation. Therefore, when only an operation of one of the two BSNs is described, the other BSN may perform the same operation. In addition, a case where the two BSNs 501 and 502 perform different operations from each other is specifically described below. In addition, the BSNs 501 and 502 illustrated in FIG. 5 may be in a state in which energy capable of performing backscattering is stored (or harvested) and preparation for transmitting a desired signal is completed. Operations of FIG. 5 may be operations in a slot allocated to the cluster including the BSNs 501 and 502, which belongs to the transmission duration 420 described with reference to FIG. 4.

In step S510, the CE 310 may transmit a continuous-wave signal to the two BSNs 501 and 502. In the example of FIG. 5, the CE 310 is illustrated as transmitting a continuous-wave signal only once in step S510, but in practice, the continuous-wave signal may be continuously transmitted. In FIG. 5, it should be noted that a case where one signal is transmitted is illustrated to exemplarily describe that the continuous-wave signal is transmitted to the BSNs 501 and 502.

In step S510, the respective BSNs 501 and 502 may receive the continuous-wave signal from the CE 310. More specifically, the respective BSNs 501 and 502 may receive the continuous-wave signal through transceiver antennas.

In step S521, controllers of the respective BSNs 501 and 502 may adjust reflection coefficients. Since only two BSNs are included in one cluster, each of the reflection coefficients may have two possible adjustable states as described with reference to FIG. 3. In other words, the controllers of the respective BSNs 501 and 502 may control the reflection coefficients such that the received continuous-wave signal and a backscattered signal are in the same phase (phase difference of) 0° or in opposite phases (phase difference of) 180°. For example, when the first BSN 501 sets a reflection coefficient such that the backscattered signal is in phase with the received continuous-wave signal, the second BSN 502 may set a reflection coefficient such that the backscattered signal is 180° out of phase with the received continuous-wave signal.

As described above for configuration of one cluster, CSI of the first BSN 501 and CSI of the second BSN 502 may be different from each other. For example, a channel gain of the first BSN 501 based on the CSI of the first BSN 501 may be higher than a channel gain of the second BSN 502 based on the CSI of the second BSN 502. Conversely, the channel gain of the second BSN 502 may be higher than the channel gain of the first BSN 501. However, hereinafter, for convenience of description, a case is assumed in which the channel gain of the first BSN 501 is higher than the channel gain of the second BSN 502.

The first BSN 501 having the higher channel gain may transmit a backscattered signal with a low transmission power. However, the second BSN 502 having the lower channel gain may transmit a backscattered signal with a high transmission power. Accordingly, the reflection coefficients may be set differently. A method of setting reflection coefficients is described in more detail below.

In step S522, modulators of the respective BSNs 501 and 502 may perform channel coding and modulation on a signal in phase with the received continuous-wave signal or a signal in opposite phase with the received continuous-wave signal. In the present disclosure, the modulators of the respective BSNs 501 and 502 may perform modulation by the BPSK scheme, for example. As described with reference to FIG. 3, the modulators of the respective BSNs 501 and 502 may also modulate signals to be backscattered by using modulation schemes other than the BPSK modulation scheme.

The signals modulated in step S522 may be backscattered and transmitted through a transceiver antenna. As described in step S521, the first BSN 501 having the higher channel gain may transmit a backscattered signal with a low transmission power, and the second BSN 502 having the lower channel gain may transmit a backscattered signal with a high transmission power.

In steps S530a and S530b, as described with reference to FIG. 3, the backscattered signal transmitted by each of the BSNs 501 and 502 may include a backscattered signal transmitted to the RIS node 330 through a reflection link (step S530b) and a backscattered signal transmitted to the BR 340 through a direct link (step S530a).

Step S530a may correspond to a case where the backscattered signal is transmitted through a direct link from the BSN to the BR 340, and step S530b may correspond to a case where the backscattered signal is transmitted through a first link (a link from the BSN to the RIS) among reflection links. Step S530b may correspond to a procedure of receiving backscattered signals from all the BSNs 501 and 502 included in one cluster. Accordingly, in step S530b, the RIS node 330 may receive backscattered signals through the first link from the respective BSNs 501 and 502.

In step S540, the RIS node 330 may adjust a phase shift value for each of backscattered signals received (or incident) from the respective BSNs 501 and 502. In addition, the RIS node 330 may configure (or adjust or control) a second link among reflection links such that each of the backscattered signals received (or incident) from the respective BSNs 501 and 502 is reflected (or transmitted) toward the BR 340. Although not illustrated in FIG. 5, the RIS node 330 may further have a configuration of amplifying the backscattered signal 530b when necessary.

In step S550, the RIS node 330 may reflect (or transmit) each of the backscattered signal from the first BSN 501 and the backscattered signal from the second BSN 502 to the BR 340 through the second link among reflection links. Accordingly, in step S550, the BR 340 may receive the backscattered signals reflected from the RIS node 330. In other words, the BR 340 may receive a combined signal of the backscattered signal received in step S530a and the backscattered signal received in step S550. As such, the signal received from all BSNs included in one cluster may be the signal described in Equation 4 above.

In step S560, the BR 340 may perform the SIC algorithm. Since the SIC algorithm has already been described in Section [2], a detailed description of a specific method is omitted. In step S560, the BR 340 may demodulate symbols from the received signal. When each of the BSNs 501 and 502 transmits the backscattered signal using the BPSK modulation scheme, the BR 340 may use a BPSK demodulation scheme. For signal demodulation, the BR 340 may perform a procedure of separating signals received respectively from the BSNs 501 and 502 from the combined signal, as described above. Since the above-described separation procedure has already been described, a redundant description is omitted.

[3.1] Method of setting a reflection coefficient of the first BSN

Hereinafter, a method of determining a reflection coefficient of a BSN having a strong signal from the perspective of the BR 340 according to the present disclosure is described. In the following description, for convenience of description, the case in which one cluster is configured with two BSNs 501 and 502, which is the same assumption as above, is assumed. However, this is merely one assumption for convenience and for aiding understanding of the present disclosure, and one cluster may be configured with three or more BSNs.

In addition, in the following description, a case in which a backscattered signal received from the first BSN 501 is a strong signal (higher received signal strength) from the perspective of the BR 340 is assumed. Here, the backscattered signal received from the first BSN 501 from the perspective of the BR 340 may be understood as a combined signal of a backscatter signal received through a direct path from the first BSN 501 and a backscatter signal of the first BSN 501 reflected by the RIS node. In the same manner, the backscatter signal received from the second BSN 502 from the perspective of the BR 340 may be understood as a combined signal of a backscatter signal received through a direct path from the second BSN 502 and a backscatter signal of the second BSN 502 reflected by the RIS node. Hereinafter, for convenience of description, the terms “backscattered signal received from the first BSN 501” and “backscattered signal received from the second BSN 502” are used.

Since one cluster is assumed to be configured with two BSNs according to the present disclosure, the backscattered signal received from the second BSN 502 may be a weak signal (lower signal strength) from the perspective of the BR 340.

In FIG. 3 described above, elements configuring the RIS node 330 (e.g. passive elements such as metamaterial or active elements capable of amplification) may have a uniform planar array (UPA) form. Therefore, the RIS node 330 may correspond to a case that supports a multi-cluster bistatic backscatter communication. In addition, each of the CE 310, the BSNs, and the BR 340 may be assumed to have a single antenna.

According to an exemplary embodiment of the present disclosure, when setting a reflection coefficient, from the perspective of the BR 340, the BR 340 may set a higher reflection coefficient for the first BSN 501 transmitting a backscattered signal having a stronger signal (or higher received signal strength) among backscattered signals received. When demodulating the combined signal in which the backscattered signal of the first BSN 501 and the backscattered signal of the second BSN 502 are combined, the BR 340 may first demodulate the backscattered signal received from the first BSN 501 having the higher received signal strength. A backscatter signal having a high reflection coefficient generally has a high signal-to-noise ratio (SNR). Therefore, the BR 340 may improve demodulation performance by first demodulating the backscattered signal received from the first BSN 501 having a higher received signal strength. In addition, the BR 340 may reduce interference by first demodulating the signal received from the first BSN 501 having a higher received signal strength in the combined signal.

The reflection coefficients determined for the respective BSNs in the cluster may be transmitted in advance by the BR 340 to each of the BSNs. The reflection coefficients for the respective BSNs in the cluster may also be transmitted together when transmitting cluster configuration information and cluster transmission slot information.

Meanwhile, when the BR 340 demodulates the backscattered signal received from the first BSN 501 from the combined signal, a signal backscattered and received from the second BSN 502 may be regarded as inter-user interference (IUI), and the BR 340 may perform maximum likelihood detection (MLD). When perfect CSI is assumed at the BR 340, an estimated data symbol obtained by demodulating a symbol received through the backscattered signal from the first BSN 501 may be expressed as Equation 5 below.

$${\hat{x}}_{1} = arg {min}_{{\tilde{x}}_{1} ∈ 𝒮} {\vert y - \sqrt{{Γ}_{1} {P}_{T}} {h}_{b , 1} {\tilde{x}}_{1} \vert}^{2} \qquad [ Equation 5 ]$$

In Equation 5, \hat{x}₁ may denote an estimated data symbol demodulated from a symbol received through the backscattered signal from the first BSN 501, and may be a possible candidate value of x₁. Since the present disclosure assumes the case in which one cluster is configured with two BSNs and the BPSK modulation scheme is used, a set S of all signal constellation points representing possible candidate values of x₁ may be {−1, +1}.

After the BR 340 completes demodulation of the backscattered signal received from the first BSN 501 in the combined signal, the BR 340 may remove the backscattered signal received from the first BSN 501 from the combined signal. Then, the BR 340 may demodulate the signal received from the second BSN 502 again by using an MLD scheme for the signal in which only the backscattered signal received from the second BSN 502 remains after removing the backscattered signal received from the first BSN 501 from the combined signal.

Meanwhile, the symbol obtained by demodulating the backscattered signal received from the first BSN 501 may have an error in a demodulated bit by a bit error rate (BER) (or may have an error frequency on average as much as the BER). In other words, the demodulation result \hat{x}₁ of the symbol of the backscattered signal of the first BSN 501 at the BR 340 may be output as a different result value from a data symbol x₁ transmitted by the first BSN 501 as much as the BER.

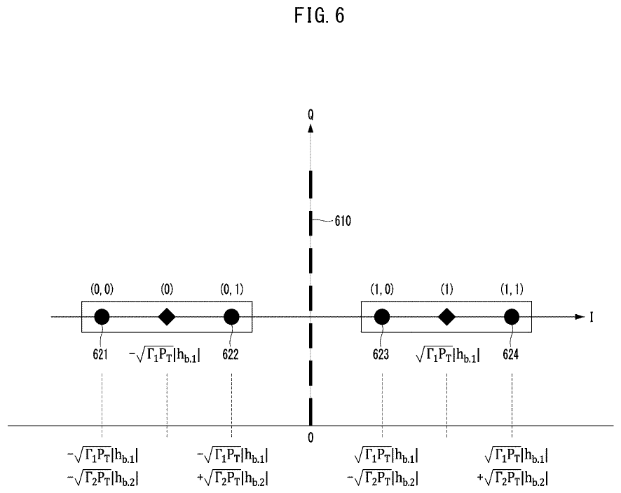

FIG. 6 is a conceptual diagram illustrating signal constellations for symbols received at the BR from the first BSN.

Referring to FIG. 6, a horizontal axis may represent an in-phase (I) component, and a vertical axis may represent a quadrature (Q) component. Since the present disclosure assumes a case in which the BPSK scheme is used, there may be no constellation points corresponding to the quadrature (Q) component, and the constellation may be represented only by constellation points of the in-phase (I) component. Therefore, the vertical axis, which is the quadrature (Q) component, may be understood as a decision boundary 610 for detecting a BPSK symbol x₁ of the first BSN 501.

Since the BR 340 receives signals from all BSNs included in one cluster, a signal received by the BR 340 may be a combined signal of signals transmitted by the respective BSNs as expressed in Equation 4 above. Since each of the BSNs transmits a symbol modulated using the BPSK scheme, the combined signal of the signals transmitted by the respective BSNs may have a form in which BPSK-modulated symbols are superimposed.

Since the present disclosure assumes the case in which one cluster is configured with two BSNs, combinations of signals transmitted by the two BSNs may be classified into four types. Circular marks 621, 622, 623, and 624 in FIG. 6 may represent examples of values obtained by the BR 340 demodulating for the symbol received from the first BSN 501 when a modulation symbol (first modulation symbol) modulated in the BPSK scheme by the first BSN 501 and a modulation symbol (second modulation symbol) modulated in the BPSK scheme by the second BSN 502 are received in form of a pair (first modulation symbol, second modulation symbol).

In other words, the circular marks 621, 622, 623, and 624 in FIG. 6 may be values obtained when the BR 340 demodulates the signal received from the first BSN 501 when the first BSN 501 and the second BSN 502 transmits a pair of modulation symbols in form of (first modulation symbol, second modulation symbol).

For example, the demodulated value 621 of the first BSN 501 due to a pair (0, 0) of modulation symbols may be a value obtained by the BR 340 demodulating the signal received from the BSN 510, when the first modulation symbol modulated by the first BSN 501 in the BPSK scheme is ‘0’ and the second modulation symbol modulated by the second BSN 502 in the BPSK scheme is ‘0’.

The demodulated value 622 of the first BSN 501 due to a pair (0, 1) of modulation symbols may be a value obtained by the BR 340 demodulating the signal received from the first BSN 501, when the first modulation symbol modulated by the first BSN 501 in the BPSK scheme is ‘0’ and the second modulation symbol modulated by the second BSN 502 in a BPSK scheme is ‘1’.

In the same manner, the demodulated value 623 of the first BSN 501 due to a pair (1, 0) of modulation symbols may be a value obtained by the BR 340 demodulating the signal received from the first BSN, when the first modulation symbol modulated by the first BSN 501 in the BPSK scheme is ‘1’ and the second modulation symbol modulated by the second BSN 502 in the BPSK scheme is ‘0’.

In addition, the demodulated value 624 of the first BSN 501 due to a pair (1,1) of modulation symbols may be a value obtained by the BR 340 modulating the signal received from the first BSN 501, when the first modulation symbol modulated by the first BSN 501 in the BPSK scheme is ‘1’ and the second modulation symbol modulated by the second BSN 502 in the BPSK scheme is ‘1’.

A distance from the decision boundary 610 to the BPSK symbol x₁ of the first BSN 501 in FIG. 6 may vary according to a received power u₁ of the backscattered signal received from the first BSN 501. When [symbol] (A) denotes a probability that an event A occurs, by considering the signal constellation of FIG. 6, a probability value that an error occurs according to the received power u₁ of the backscattered signal received from the first BSN 501 may be expressed as Equation 6 below.

$${P}_{e} ( {u}_{1} ) = \frac{1}{2} [ ( \frac{{1}_{} + {2}_{}}{\sqrt{{σ}^{2} / 2}} ) + ( \frac{{1}_{} - {2}_{}}{\sqrt{{σ}^{2} / 2}} ) ] \qquad [ Equation 6 ]$$

In Equation 6, [symbol] may denote a Gaussian Q-function having a factor proportional to an instantaneous SNR of the received signal. [symbol] ᵢ may be obtained as a sum of a Nakagami-distributed random variable and a gamma-distributed random variable, and may be approximated as another gamma-distributed random variable. [symbol] ᵢ may be expressed as Equation 7 below.

$${i}_{} = \sqrt{{Γ}_{i} {P}_{T}} \vert {h}_{b , i} \vert \qquad [ Equation 7 ]$$

In Equation 7, h_{b,i} may denote a channel function between the RIS node 330 and the i-th BSN.

In Equation 6, factors of the Q-function expressed as a sum and a difference of channel functions between the RIS node 330 and the i-th BSN may be defined as Equations 8 and 9 below.

$$= \frac{{1}_{} + {2}_{}}{\sqrt{{σ}^{2} / 2}} \qquad [ Equation 8 ]$$

$$= \frac{{1}_{} - {2}_{}}{\sqrt{{σ}^{2} / 2}} \qquad [ Equation 9 ]$$

Probability density functions (PDFs) of [symbol] of Equation 8 and [symbol] of Equation 9 may be sums of scaled Nakagami-m random variables. Due to approximation, the PDFs may be expressed as mutually independent Gaussian random variables.

To evaluate an average BER of the backscattered signal received from the first BSN 501, an integral of a Gaussian Q-function weighted by an instantaneous SNR of the received signal and a fading distribution of a propagation channel may be computed. The average BER according to the received power u₁ of the backscattered signal received from the first BSN 501 may be expressed as Equation 10 below.

$$\overline{{P}_{e} ( {1}_{} )} = \frac{1}{2} [ ( \frac{\sqrt{{σ}_{𝒰}^{2} + 1}}{} ) + ( \frac{\sqrt{{σ}_{V}^{2} + 1}}{} ) ] \qquad [ Equation 10 ]$$

In Equation 10, μ [symbol] may denote a mean of the random variable [symbol] , and μ [symbol] may denote a mean of the random variable [symbol] .

may be a vallance of the random variables [symbol] , and

may be a variance of the random variable [symbol] .

### [3.2] Method of Setting a Reflection Coefficient of the Second BSN

Hereinafter, a method of determining a reflection coefficient of a BSN having a weak signal from the perspective of the BR 340 according to the present disclosure is described. In the following description, for convenience of description, a case in which one cluster is configured with two BSNs 501 and 502, which is the same assumption as above, is assumed. However, this is merely one assumption for convenience and for aiding understanding of the present disclosure, and one cluster may be configured with three or more BSNs.

In addition, in the following description, a BSN having a strong signal (higher received signal strength) is assumed to be the first BSN 501 from the perspective of the BR 340. Therefore, from the perspective of the BR 340, the second BSN 502 may be a BSN having a weak signal (lower received signal strength).

According to an exemplary embodiment of the present disclosure, a reflection coefficient setting method may set a lower reflection coefficient for the second BSN 502, which is a BSN having a weak signal (lower received signal strength) from the perspective of the BR 340 among signals received. Since the second BSN 502 has the lower reflection coefficient, a backscattered signal transmitted by the second BSN 502 may cause less interference to a backscattered signal transmitted by the first BSN 501 from the perspective of the BR 340. In other words, due to the lower reflection coefficient of the second BSN 502, the BR 340 may receive the backscattered signal from the second BSN 502 at a low SNR. In addition, as described in Section [3.1] above, since a strong signal is first demodulated and then a weak signal is demodulated, interference due to a strong backscattered signal in the SIC process is reduced, and BER performance may be maintained. In other words, detection of the backscattered signal of the second BSN 502 through an SIC demodulation process may be performed after the BR 340 demodulates symbols transmitted through the backscattered signal received first from the first BSN 501.

When the BR 340 succeeds in demodulating the symbol received through the backscattered signal received from the first BSN 501, the BR 340 may perform demodulation without IUI when demodulating the backscattered signal received from the second BSN 502.

Meanwhile, when a bit error occurs according to a BER in the signal received from the first BSN 501 when the BR 340 demodulates the symbol received through the backscattered signal received from the first BSN 501, IUI may be caused when the BR 340 demodulates a symbol received through the backscattered signal received from the second BSN 502.

Since the BR 340 has demodulated an estimated data symbol of the backscattered signal received from the first BSN 501 through the procedure of Section [3.1] above, the BR 340 may remove the backscattered signal received from the first BSN 501 from the combined signal of backscatter signals. A signal from which the backscattered signal received from the first BSN 501 is removed in the combined signal of backscattered signals may be the backscattered signal received from the second BSN 502. Therefore, the BR 340 may demodulate the backscattered signal received from the second BSN 502. An estimated data symbol obtained by demodulating the backscattered signal received from the second BSN 502 may be expressed as Equation 11 below.

$${\hat{x}}_{2} = arg {min}_{{\tilde{x}}_{2} ∈ 𝒮} {\vert ( y - \sqrt{{Γ}_{1} {P}_{T}} {h}_{b , 1} {\tilde{x}}_{1} ) - \sqrt{{Γ}_{2} {P}_{T}} {h}_{b , 2} {\tilde{x}}_{2} \vert}^{2} = arg {min}_{{\tilde{x}}_{2} ∈ 𝒮} {\vert {y}_{SIC} - \sqrt{{Γ}_{2} {P}_{T}} {h}_{b , 2} {\tilde{x}}_{2} \vert}^{2} \qquad [ Equation 11 ]$$

In Equation 11, \hat{x}₂ may denote an estimated data symbol demodulated from the symbol received through the backscatter signal from the second BSN 502, and \tilde{x}₂ may be a possible candidate value of x₂. Since the present disclosure assumes a case in which one cluster is configured with two BSNs and the BPSK modulation scheme is used, a set S of all signal constellation points representing possible candidate values of x₂ may be {−1, +1}. In addition, y_{SIC} may be a signal finally obtained at the BR 340 after the SIC process.

Meanwhile, as described above, based on the demodulation result of the backscattered signal received from the first BSN 501, a received signal of the backscattered signal received from the second BSN 502 may be expressed differently. When expressed as an equation, it may be expressed as Equation 12 below.

$${y}_{SIC} = \{ \begin{matrix}\sqrt{{Γ}_{2} {P}_{T}} {h}_{b , 2} {x}_{2} + w & {\hat{x}}_{1} = {x}_{1} \\ \sqrt{{Γ}_{1} {P}_{T}} {h}_{b , 1} {x}_{1} ) - & {\hat{x}}_{1} \neq {x}_{1} \\ \sqrt{{Γ}_{1} {P}_{T}} {h}_{b , 1} {\hat{x}}_{1} + \sqrt{{Γ}_{2} {P}_{T}} {h}_{b , 2} {x}_{2} + w & \end{matrix} \qquad [ Equation 12 ]$$

As illustrated in Equation 11, y_{SIC} may have a different value according to the demodulation result of the first BSN 501. An upper term of Equation 11 may be a signal finally obtained at the BR 340 in a case of a successful demodulation of the backscattered signal received from the first BSN 501, and a lower term of Equation 11 may be a signal finally obtained at the BR 340 in a case where an error occurs in the demodulation result of the backscattered signal received from the first BSN 501. Based on these results, the BR 340 may cause a bit error of the backscattered signal received from the second BSN 502 according to a success or failure of the backscattered signal received from the first BSN 501.

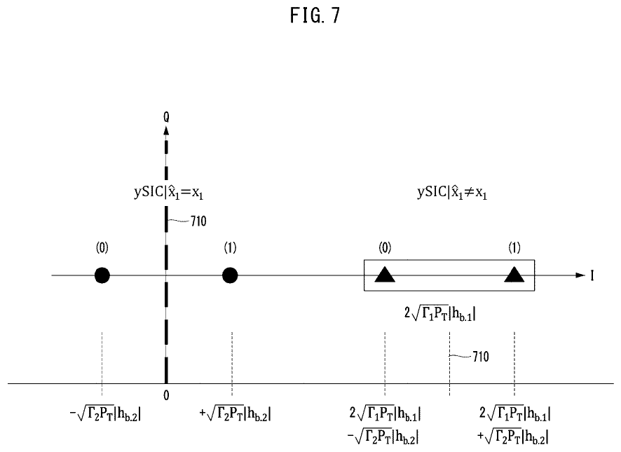

FIG. 7 is a conceptual diagram illustrating signal constellations for symbols received at the BR from the second BSN.

Referring to FIG. 7, a horizontal axis may indicate an in-phase I component, and a vertical axis may indicate a quadrature Q component. The present disclosure assumes a case in which the BPSK scheme is used, and thus describes a case in which constellation points according to the quadrature Q component do not exist and constellation points according to the in-phase I component exist.

In FIG. 7, the vertical axis corresponding to the quadrature Q component may be understood as a decision boundary 710 for detecting a BPSK symbol x₂ of the second BSN 502. As described above, a value of the decision boundary 710 for detecting the BPSK symbol x₂ of the second BSN 502 may be a value set when demodulation of the first BSN 501 succeeds. In other words, a transmitted symbol value of the first BSN 501 and a demodulated result value at the BR 340 may be the same.

On the contrary, when the transmitted symbol value of the first BSN 501 and the demodulated result value at the BR 340 are different, due to a bit error of the first BSN 501, the signal transmitted by the first BSN 501 including the bit error is removed from a combined signal in which signals transmitted by respective BSNs are combined. Thus, a position of the decision boundary for detecting the BPSK symbol x₂ of the second BSN 502 may be understood as changed as shown with reference numeral 720. Therefore, when a bit error occurs in the first BSN 501, a BER of the second BSN 502 may be significantly increased.

When the demodulation result of the backscattered signal received from the first BSN 501 does not include a bit error (i.e. \hat{x}₁=x₁), a BER of the backscattered signal received from the second BSN 502 may be expressed as Equation 13 below.

$${P}_{e}^{I} ( {2}_{} ) = \frac{1}{2} [ ( n \geq {2}_{} ) \cdot ( {2}_{} \leq n \leq {1}_{} + {2}_{} ) ] = ( ) - \frac{1}{2} ( ) , = \frac{{2}_{}}{\sqrt{{σ}^{2} / 2}} \qquad [ Equation 13 ]$$

When the demodulation result of the backscattered signal received from the first BSN 501 includes a bit error (i.e. \hat{x}₁≠x₁), the BER of the backscattered signal received from the second BSN 502 may be expressed as Equation 14 below.

$${P}_{e}^{II} ( {2}_{} ) = \frac{1}{2} [ ( n \geq 2 \cdot {1}_{} + {2}_{} ) + ( {1}_{} - {2}_{} \leq n \leq 2 \cdot {1}_{} - {1}_{} ) ] = \frac{1}{2} [ ( ) + ( ) - ( ) ] , \qquad [ Equation 14 ]$$

$$= \frac{2 \cdot {1}_{} + {2}_{}}{\sqrt{{σ}^{2} / 2}} , = \frac{2 \cdot {1}_{} - {2}_{}}{\sqrt{{σ}^{2} / 2}}$$

By using Equation 13 and Equation 14, an average BER of the backscattered signal received from the second BSN 502 may be expressed as Equation 15 below.

$$\overline{{P}_{e} ( {2}_{} )} = ( \frac{{μ}_{}}{\sqrt{{σ}_{2}^{} + 1}} ) + \frac{1}{2} [ - ( \frac{\sqrt{+ 1}}{} ) + ( \frac{\sqrt{+ 1}}{} ) + ( \frac{\sqrt{+ 1}}{} ) - ( \frac{\sqrt{+ 1}}{} ) ] \qquad [ Equation 15 ]$$

### [3.3] Performance of BSNs

Hereinafter, performance of signals received from the BSNs is described in the case in which the method according to Section 3, Section 3.1, and Section 3.2 described in the present disclosure is used. Therefore, a description below describes performance regarding a case in which one cluster is configured with the two BSNs 501 and 502.

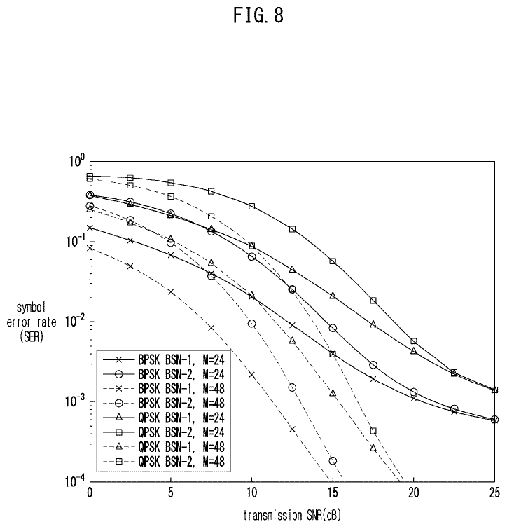

FIG. 8 is a simulation graph illustrating a symbol error rate when the first BSN and the second BSN use a BPSK modulation scheme and a QPSK modulation scheme.

Referring to FIG. 8, a case in which each of the first BSN 501 and the second BSN 502 uses the BPSK modulation scheme and a case in which each of the first BSN 501 and the second BSN 502 uses a quadrature phase-shift keying (QPSK) modulation scheme may be distinguished. In FIG. 8, the first BSN 501 is illustrated as BSN-1, and the second BSN 502 is illustrated as BSN-2. In addition, FIG. 8 illustrates simulation results for a case in which the number M of reflection elements of the RIS node 330 is 24 and a case in which the number M of reflection elements of the RIS node 330 is 48.

As illustrated in FIG. 8, when the BPSK modulation scheme is used, a symbol detection probability at the BR 340 is higher compared to the QPSK modulation scheme. In order to achieve a symbol error rate (SER) performance identical to the BPSK scheme by using the QPSK modulation scheme, an additional SNR of an average 5 dB is required.

In addition, as the number M of elements of the RIS node 330 increases, channel gain may increase. Thus, in a high SNR region, the QPSK modulation scheme assuming M=48 may show performance higher than the BPSK modulation scheme assuming M=24.

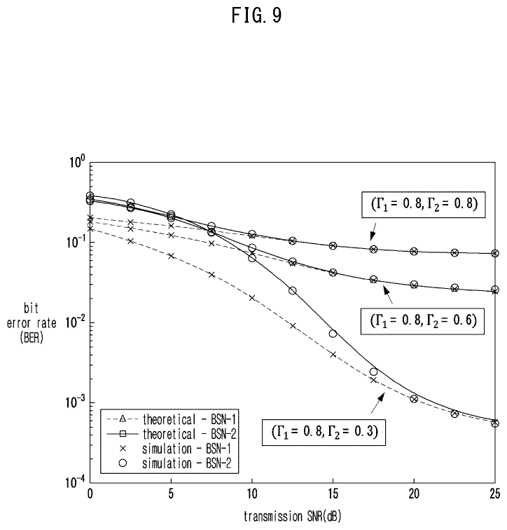

FIG. 9 is a simulation graph illustrating performance according to reflection coefficients of the first BSN and the second BSN.

In FIG. 9, the first BSN 501 is illustrated as BSN-1, and the second BSN 502 is illustrated as BSN-2. FIG. 9 may be a graph comparing theoretical BER performances for the respective BSNs based on the methods described in Section 1 to Section 3 including Section 3.1 and Section 3.2 of the present disclosure with BER performances obtained through MATLAB-based experiments according to reception sensitivity. As illustrated in FIG. 9, experimental results are consistent with contents described through equations according to reflection coefficients. Therefore, equations proposed in the present disclosure are valid. By using the simulation graph of FIG. 9, performance of a designed system according to equations of the present disclosure may be predicted, and the reflection coefficient of the BSN in the network may be adjusted according to system requirements.

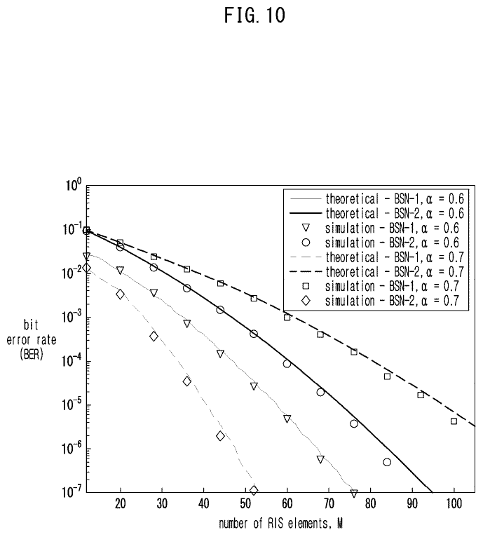

FIG. 10 is a simulation graph comparing BER performances for the first BSN and the second BSN according to a number of reflection elements of the RIS node.

In FIG. 10, the first BSN 501 is illustrated as BSN-1, and the second BSN 502 is illustrated as BSN-2. FIG. 10 may be a result comparing a theoretical BER equation per BSN and a BER performance obtained through MATLAB-based experiments according to a number of RIS elements, based on the method described above. As the number M of elements of the RIS node 330 increases, signal amplification by the RIS node 330 may be enhanced. A division coefficient value a may indicate a proportion of the elements of the RIS node 330 assigned to the first BSN 501 among the elements of the entire RIS node 330. Therefore, according to division of the number of elements of the RIS node 330, a difference in BER performance between the first BSN 501 and the second BSN 502 may increase. Based on this result, the division coefficient value a may be applied differently according to system requirements and network goals.

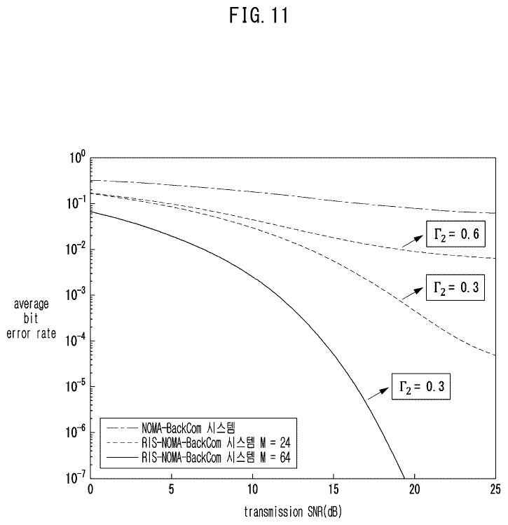

FIG. 11 is a simulation graph evaluating average BER performance according to a transmission SNR and whether an RIS node is included.

In FIG. 11, the first BSN 501 is illustrated as BSN-1, and the second BSN 502 is illustrated as BSN-2. FIG. 11 may be a simulation graph comparing average BER performance when the RIS node 330 is included and when the RIS node 330 is not included in the NOMA and backscatter communication system. Referring to FIG. 11, even without an optimal reflection coefficient value, the system proposed by the present disclosure may show performance superior to a system with no RIS node.

A reason for the result exemplified by the simulation graph illustrated in FIG. 11 is that backscattered signals reflected by the RIS node 330 are consistently combined at the BR 340 with backscattered signals arriving through a direct path, and thus the entire signal (all backscattered signals) received at the BR 340 becomes stronger. Accordingly, in the system according to the present disclosure using the RIS node 330, SNR and BER may be improved.

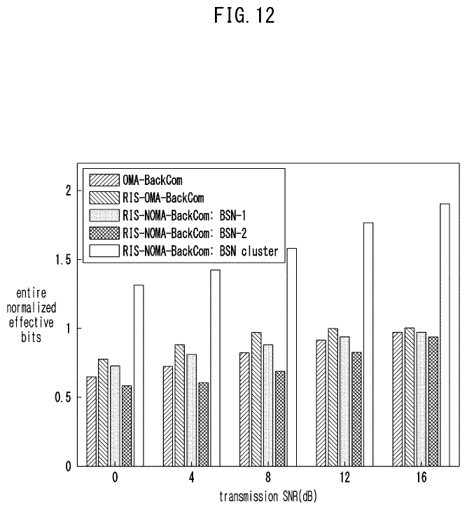

FIG. 12 is a graph evaluating performance according to a transmission SNR and a number of transmitted bits according to a change in a multiple access scheme.

Referring to FIG. 12, when an RIS node is included in a currently known backscatter system, a number of effectively transmitted bits increases. Even though inter-user interference (IUI) occurs in a demodulation process when the NOMA scheme is used, since two symbols may be simultaneously transmitted to the BR 340 within one transmission slot, performance may be superior to that of an OMA scheme.

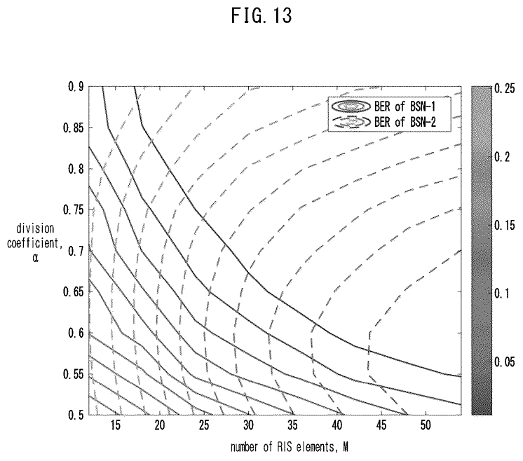

FIG. 13 is a simulation graph comparing BER performances for the first BSN and the second BSN according to a change in a number of reflection elements of the RIS node and a change in a division coefficient value.

In FIG. 13, the first BSN 501 is illustrated as BSN-1, and the second BSN 502 is illustrated as BSN-2. Referring to FIG. 13, BER values are compared according to a setting of a division coefficient α for the reflection elements of the RIS node 330 supporting the first BSN 501 and the second BSN 502 along with a change in the number M of reflection elements of the RIS node 330.

An increase of the division coefficient α may directly affect improvement of BER performance of the first BSN 501 regardless of the number M of reflection elements, and due to a difference in reception signal strengths of backscattered signals of the first BSN 501 and the second BSN 502, the backscattered signal of the first BSN 501 may have lower IUI, thereby increasing a symbol detection probability. In addition, due to a reduction of an error propagation probability in the SIC demodulation process, BER performance of the second BSN 502 may also be improved.

Meanwhile, when the division coefficient α exceeds an optimal value, a signal strength for the backscattered signal of the second BSN 502 may significantly decrease, and a demodulation error probability may significantly increase, so performance of the second BSN 502 decreases. At a transmission SNR of 5 dB, when the division coefficient α is 0.6, it may be confirmed that the BER performances of the first BSN 501 and the second BSN 502 are minimized.

FIG. 14 is a flowchart describing a training and backscatter signal reception procedure at the BR of the NOMA-based RIS-supported backscatter system.

Before describing the flowchart of FIG. 14, it should be noted that the procedure of FIG. 14 may be performed at the BR 340 or at a control node not illustrated in FIG. 3 controlling the system according to the present disclosure. Hereinafter, for convenience and aid of understanding, a case in which the procedure is performed at the BR 340 is assumed.

In step S1400, the BR 340 may transmit training duration configuration information to the BSNs. The training duration configuration information may include at least one of a start time, an end time, or a number of slots of the training duration 410. In addition, the training duration configuration information may further include training slot assignment information. The training slot assignment information may further include information on a time slot for a specific BSN to perform backscattering. The training slot assignment information may vary according to a number of BSNs included in the NOMA-based RIS-supported backscatter system, as described in FIG. 4.

In step S1400, each BSN included in the NOMA-based RIS-supported backscatter system may receive the training duration configuration information from the BR 340. Each BSN may identify a training duration based on the received training duration configuration information and may identify a training slot assigned thereto.

In step S1410, the BR 340 may receive backscattered signals transmitted by the respective BSNs through the training slots assigned to the respective BSNs in the training duration 410. In other words, in step S1410, each BSN may backscatter a continuous wave signal transmitted by the CE 310 in its own training slot based on the training duration configuration information and may transmit the backscattered signal to the BR 340. In this case, the RIS node 330 may be in a non-operating state.

In step S1410, the BR 340 may measure or estimate CSI by using the received backscattered signals, and based on the measured CSI, the BR 340 may identify or calculate channel gains of the BSNs.

In step S1420, the BR 340 may sort the BSNs in descending order from a BSN having the highest channel gain to a BSN having the lowest channel gain based on the measured CSI.

In step S1430, the BR 340 may map the BSNs sorted in descending order to clusters. Since the method for mapping the BSNs sorted in descending order to clusters has been described above, a redundant description is omitted. The BR 340 may generate cluster information regarding the BSNs mapped to the clusters. The cluster information may include a cluster identifier of each cluster and information on BSN(s) included in each cluster. For example, when the first BSN 501 and the second BSN 502 are mapped to a first cluster, the cluster information may be provided by mapping an identifier of the first cluster with identifiers of the first BSN 501 and the second BSN 502. The cluster information may be transmitted as being included in cluster configuration information. The cluster configuration information may further include transmission duration information and information on a transmission slot for each cluster. The transmission duration configuration information may include at least one of a start time, an end time, a total number of transmission slots in the transmission duration 420, a repetition pattern of the transmission duration, or periodicity information of the transmission duration. In addition, the transmission duration configuration information may include information on a transmission slot for each cluster described in FIG. 4.

Although not illustrated in FIG. 14, in step S1430, the BR 340 may determine a reflection coefficient for each BSN included in each cluster and may transmit the determined reflection coefficient through the transmission duration configuration information or through separate information. Therefore, each of all BSNs may receive its own reflection coefficient value (or, information related thereto) from the BR 340.

In step S1430, the BR 340 may also determine a division coefficient value a of the RIS node 330. The division coefficient value a of the RIS node 330 may be determined based on an optimization algorithm of the division coefficient or a simultaneously transmitting and reflecting (STAR)-RIS scheme. According to an exemplary embodiment of the present disclosure, the division coefficient value of the RIS node 330 may be determined based on the measured CSI. The BR 340 may generate division coefficient configuration information based on the division coefficient value.

In step S1440, the BR 340 may transmit the cluster configuration information to each BSN. In step S1440, each BSN in the NOMA-based RIS-supported backscatter system may receive the cluster configuration information from the BR 340. Therefore, each BSN may identify at least one of a start time, an end time, a total number of transmission slots in the transmission duration 420, a repetition pattern of the transmission duration, or periodicity information of the transmission duration 420 from the received cluster configuration information. In addition, each BSN may identify a transmission slot for each cluster from the received cluster configuration information and may identify a slot in which itself transmits a backscattered signal.

In addition, in step S1440, the BR 340 may transmit the division coefficient configuration information to the RIS node 330 based on the division coefficient value. Therefore, the RIS node 330 may determine a division ratio of the reflection elements of the RIS node 330 based on the division coefficient configuration information received from the BR 340.

In step S1450, the BR 340 may receive backscattered signals from BSNs included in each cluster in the transmission slot for each cluster. In other words, in step S1450, each BSN may backscatter a continuous wave signal transmitted by the CE 310 in its own transmission slot based on the transmission duration configuration information and may transmit the backscattered signal to the BR 340. In the transmission duration, the RIS node 330 may divide elements of the RIS node 330 based on the division coefficient and may reflect the backscattered signals received from the BSNs to the BR 340 via the divided elements. In other words, in the transmission duration, the RIS node 330 may be in an operating state.

In step S1450, the BR 340 may receive the backscattered signals from BSNs included in each cluster and the backscattered signals reflected by the RIS node 330. In addition, the BR 340 may demodulate and decode a combined form of the backscattered signals transmitted by two or more BSNs. Since the method and the procedure for demodulating and decoding the combined form of the backscattered signals by the BR 340 have been described above, a redundant description is omitted.

When the transmission duration is repeated, step S1450 may be performed in each subsequent repeated duration. In addition, when a BSN is added to or removed from the NOMA-based RIS-supported backscatter system, step S1400 may be performed again.

The procedure of FIG. 14 described above has been described under the assumption that the procedure is performed at the BR 340. However, when the BR 340 and the CE 310 are connected through a backhaul network, the transmission procedure described in FIG. 14 may be performed by the CE 310. In other words, the training configuration information and/or the transmission configuration information may be transmitted from the CE 310.

Meanwhile, in the training duration 410, the RIS node 330 may not operate. In order to prevent the RIS node 330 from operating in the training duration 410, the BR 340 may be connected to the RIS node 330 via a direct connection or a backhaul network. Therefore, although not additionally described in FIG. 14, the BR 340 may transmit the training duration configuration information to the RIS node 330 to prevent operation in the training duration.

On the other hand, when the control procedure of FIG. 14 is performed at a specific control node not illustrated in FIG. 3, the specific control node may control the RIS node 330 to prevent the RIS node 330 from operating in the training duration and may control the RIS node 330 to perform reflection operations in the transmission duration.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a backscatter receiver in a backscatter communication system, comprising:
receiving a combined backscattered signal in which direct backscattered signals transmitted from a first backscatter node (BSN) and a second BSN included in a first cluster through direct paths and reflected backscattered signals reflected by a reconfigurable intelligent surface (RIS) node are combined;
demodulating, among the direct backscattered signals, a backscattered signal having a larger received signal strength based on a comparison between a received signal strength of a first direct backscattered signal from the first BSN and a received signal strength of a second direct backscattered signal from the second BSN;
generating a remaining signal by removing, from the combined backscattered signal, the backscattered signal having the larger received signal strength based on the demodulated backscattered signal; and
demodulating the remaining signal.

2. The method of claim 1, further comprising:
generating cluster configuration information including information on BSNs included in each of clusters including the first cluster, transmission duration information on a transmission duration in which data transmission of each of the clusters is permitted, and information on a transmission slot allocated to each cluster in a transmission duration based on the transmission duration information; and
transmitting the cluster configuration information to all BSNs included in the backscatter communication system.

3. The method of claim 2, wherein the combined backscattered signal is received in a transmission slot of the first cluster based on the cluster configuration information.

4. The method of claim 1, wherein the demodulating of the backscattered signal having the larger received signal strength comprises:
comparing the received signal strength of the first direct backscattered signal with the received signal strength of the second direct backscattered signal; and
based on the received signal strength of the first direct backscattered signal being greater than the received signal strength of the second direct backscattered signal, performing demodulation on the first direct backscattered signal and on a first reflected backscattered signal from the first BSN reflected by the RIS node.

5. The method of claim 1, further comprising:
transmitting training duration configuration information of all BSNs included in the backscatter communication system to all the BSNs;
receiving an individual backscattered signal from one BSN for each training slot based on the training duration configuration information;
measuring channel state information (CSI) for each of all the BSNs by using the received individual backscattered signals;
sorting the BSNs in an order from a BSN having a highest channel gain to a BSN having a lowest channel gain based on the measured CSI for each of all the BSNs;
mapping two different BSNs among the sorted BSNs to one cluster;
generating cluster configuration information including information on the cluster to which the two BSNs are mapped and information on a transmission slot for each cluster; and
transmitting the cluster configuration information to all the BSNs included in the backscatter communication system.

6. The method of claim 5, further comprising:
determining a reflection coefficient of the first BSN and a reflection coefficient of the second BSN based on the measured CSI for each of all the BSNs; and
transmitting the reflection coefficient of the first BSN and the reflection coefficient of the second BSN to the first BSN and the second BSN.

7. The method of claim 6, wherein the reflection coefficient of the first BSN and the reflection coefficient of the second BSN have different values from each other.

8. The method of claim 5, further comprising:
determining a division coefficient configured as information on a number of reflection elements for the RIS node to reflect backscattered signals from the first BSN and a number of reflection elements for the RIS node to reflect backscattered signals from the second BSN, based on the measured CSI for each of all the BSNs; and
transmitting the division coefficient to the RIS node.

9. The method of claim 8, wherein the division coefficient is determined based on a simultaneous transmission and reflection (STAR)-RIS scheme.

10. A backscatter receiver comprising at least one processor, wherein the at least one processor causes the backscatter receiver to perform:
receiving a combined backscattered signal in which direct backscattered signals transmitted from a first backscatter node (BSN) and a second BSN included in a first cluster through direct paths and reflected backscattered signals reflected by a reconfigurable intelligent surface (RIS) node are combined;
demodulating, among the direct backscattered signals, a backscattered signal having a larger received signal strength based on a comparison between a received signal strength of a first direct backscattered signal from the first BSN and a received signal strength of a second direct backscattered signal from the second BSN;
generating a remaining signal by removing, from the combined backscattered signal, the backscattered signal having the larger received signal strength based on the demodulated backscattered signal; and
demodulating the remaining signal.

11. The backscatter receiver of claim 10, wherein the at least one processor further causes the backscatter receiver to perform:
generating cluster configuration information including information on BSNs included in each of clusters including the first cluster, transmission duration information on a transmission duration in which data transmission of each of the clusters is permitted, and information on a transmission slot allocated to each cluster in a transmission duration based on the transmission duration information; and
transmitting the cluster configuration information to all BSNs included in the backscatter communication system.

12. The backscatter receiver of claim 10, wherein the combined backscattered signal is received in a transmission slot of the first cluster based on the cluster configuration information.

13. The backscatter receiver of claim 10, wherein in the demodulating of the backscattered signal having the larger received signal strength, the at least one processor causes the backscatter receiver to perform:
comparing the received signal strength of the first direct backscattered signal with the received signal strength of the second direct backscattered signal; and
based on the received signal strength of the first direct backscattered signal being greater than the received signal strength of the second direct backscattered signal, performing demodulation on the first direct backscattered signal and on a first reflected backscattered signal from the first BSN reflected by the RIS node.

14. The backscatter receiver of claim 10, wherein the at least one processor causes the backscatter receiver to perform:
transmitting training duration configuration information of all BSNs included in the backscatter communication system to all the BSNs;
receiving an individual backscattered signal from one BSN for each training slot based on the training duration configuration information;
measuring channel state information (CSI) for each of all the BSNs by using the received individual backscattered signals;
sorting the BSNs in an order from a BSN having a highest channel gain to a BSN having a lowest channel gain based on the measured CSI for each of all the BSNs;
mapping two different BSNs among the sorted BSNs to one cluster;
generating cluster configuration information including information on the cluster to which the two BSNs are mapped and information on a transmission slot for each cluster; and
transmitting the cluster configuration information to all the BSNs included in the backscatter communication system.

15. The backscatter receiver of claim 14, wherein the at least one processor causes the backscatter receiver to perform:
determining a reflection coefficient of the first BSN and a reflection coefficient of the second BSN based on the measured CSI for each of all the BSNs; and
transmitting the reflection coefficient of the first BSN and the reflection coefficient of the second BSN to the first BSN and the second BSN.

16. The backscatter receiver of claim 15, wherein the reflection coefficient of the first BSN and the reflection coefficient of the second BSN have different values from each other.

17. The backscatter receiver of claim 14, wherein the at least one processor causes the backscatter receiver to perform:
determining a division coefficient configured as information on a number of reflection elements for the RIS node to reflect backscattered signals from the first BSN and a number of reflection elements for the RIS node to reflect backscattered signals from the second BSN, based on the measured CSI for each of all the BSNs; and
transmitting the division coefficient to the RIS node.

18. The backscatter receiver of claim 17, wherein the division coefficient is determined based on a simultaneous transmission and reflection (STAR)-RIS scheme.

19. A method of a backscatter node in a backscatter communication system, comprising:
receiving transmission duration configuration information from a backscatter receiver;
receiving reflection coefficient information from the backscatter receiver;
receiving a continuous wave (CW) signal transmitted from a carrier emitter in a cluster transmission slot allocated to a cluster including the backscatter node based on the transmission duration configuration information;
controlling a phase of the received CW signal based on the reflection coefficient information;
generating encoded data by performing channel coding on the phase-controlled CW signal; and
transmitting a first backscattered signal to the backscatter receiver by backscattering the encoded data,
wherein the transmission duration configuration information further includes one or more of a start time of a transmission duration, an end time of the transmission duration, a number of total transmission slots in the transmission duration, a repetition pattern of the transmission duration, and periodicity information of the transmission duration.

20. The method of claim 19, further comprising:
receiving training duration configuration information from the backscatter receiver, and
transmitting a second backscattered signal to the backscatter receiver by backscattering the CW signal received from the carrier emitter in a training slot allocated to the backscatter node based on the training duration configuration information,
wherein the training duration configuration information further includes one or more of a start time of a training duration, an end time of the training duration, and a number of slots of the training duration.
